(19) United States
(12) Patent Application Publication
(10) Pub. No.: US 2026/0155732 A1
(43) Pub. Date: Jun. 4, 2026

(54) Voltage Conversion Circuit, Inverter Device, and Energy Storage Device

(71) Applicant: Anker Innovations Technology Co., Ltd., Changsha (CN)

(72) Inventors: Shijun Yu, Shenzhen (CN); Wenke Yang, Shenzhen (CN); Ziyong Fan, Shenzhen (CN); Yiyong Li, Shenzhen (CN)

(21) Appl. No.: 19/404,404

(22) Filed: Dec. 1, 2025

(30) Foreign Application Priority Data
Nov. 29, 2024 (CN) 202422950672.0

(51) Int. Cl. H02M 1/00; H02J 3/38; H02J 101/24; H02M 1/084; H02M 7/5387

(52) U.S. Cl. CPC H02M 1/0058; H02J 3/381; H02M 1/084; H02M 7/53871; H02J 2101/24

(57) ABSTRACT

The present application discloses a voltage conversion circuit, an inverter device, and an energy storage device. The voltage conversion circuit comprises an auxiliary switching circuit for a Heric topology circuit. The auxiliary switching circuit comprises a first switching unit, a second switching unit, a transformer, a first inductor, and a first diode. A first terminal of the first switching unit is connected to a positive electrode of a direct current side of the Heric topology circuit, and a second terminal of the first switching unit is connected to a first terminal of the transformer. A first terminal of the second switching unit is connected to a second terminal of the transformer, and a second terminal of the second switching unit is connected to a negative electrode of the direct current side.

### CROSS-REFERENCE TO RELATED APPLICATION

The present disclosure claims all the benefits of the Chinese patent application No. 202422950672.0 filed on Nov. 29, 2024, before the China National Intellectual Property Administration of the People's Republic of China, entitled “Voltage Conversion Circuit, Inverter Device, and Energy Storage Device,” which is incorporated herein by reference in their entirety.

### TECHNICAL FIELD

The present application relates to the technical field of conversion circuits, and in particular, to a voltage conversion circuit, an inverter device, and an energy storage device.

### BACKGROUND

Bidirectional direct current-alternating current (DC-AC) converters can be used for bidirectional conversion between direct current voltage and alternating current voltage, enabling bidirectional power flow between an alternating current side and a direct current side. With the development of technology, research on bidirectional DC-AC converter technology has received widespread attention.

In conventional DC-AC converters, the hard turn-on or hard turn-off of switching transistors may incur losses (e.g., power loss) of the switching transistors.

### SUMMARY

The main technical problem to be solved by the present application is to provide a voltage conversion circuit, an inverter device, and an energy storage device to solve the problem of losses of switching transistors.

The present application provides a voltage conversion circuit, comprising an auxiliary switching circuit for a Heric topology circuit. The auxiliary switching circuit comprises a first switching unit, a second switching unit, a transformer, a first inductor, and a first diode. A first terminal of the first switching unit is connected to a positive electrode of a direct current side of the Heric topology circuit, and a second terminal of the first switching unit is connected to a first terminal of the transformer. A first terminal of the second switching unit is connected to a second terminal of the transformer, and a second terminal of the second switching unit is connected to a negative electrode of the direct current side. A positive electrode of the first diode is connected to a third terminal of the transformer, and a fourth terminal of the transformer is connected to the negative electrode of the direct current side A first terminal of the first inductor is connected to a fifth terminal of the transformer, and a second terminal of the first inductor is connected to a midpoint of a freewheeling bridge arm in the Heric topology circuit.

The first switching unit comprises a first switching transistor and a second diode, a first terminal of the first switching transistor is connected to the positive electrode of the direct current side, a second terminal of the first switching transistor is connected to the first terminal of the transformer, a positive electrode of the second diode is connected to the second terminal of the first switching transistor, and a negative electrode of the second diode is connected to the first terminal of the first switching transistor.

The second switching unit comprises a second switching transistor and a third diode, a first terminal of the second switching transistor is connected to the second terminal of the transformer, a second terminal of the second switching transistor is connected to the negative electrode of the direct current side, a positive electrode of the third diode is connected to the second terminal of the second switching transistor, and a negative electrode of the third diode is connected to the first terminal of the second switching transistor.

The Heric topology circuit comprises a third switching unit, a fourth switching unit, a fifth switching unit, a sixth switching unit, a seventh switching unit, an eighth switching unit, a second inductor, and a third inductor. A first terminal of the third switching unit and a first terminal of the fifth switching unit are connected to the positive electrode of the direct current side. A second terminal of the third switching unit is connected to a first terminal of the fourth switching unit. A second terminal of the fourth switching unit is connected to the negative electrode of the direct current side. A second terminal of the fifth switching unit is connected to a first terminal of the sixth switching unit. A second terminal of the sixth switching unit is connected to the negative electrode of the direct current side. A first terminal of the seventh switching unit is connected to the second terminal of the third switching unit and a first terminal of the second inductor. A second terminal of the seventh switching unit is connected to a first terminal of the eighth switching unit and the second terminal of the first inductor. A second terminal of the eighth switching unit is connected to the second terminal of the fifth switching unit and a first terminal of the third inductor. A second terminal of the second inductor is connected to a first terminal of an alternating current side of the Heric topology circuit, and a second terminal of the third inductor is connected to a second terminal of the alternating current side.

The third switching unit comprises a third switching transistor and a fourth diode. A first terminal of the third switching transistor is connected to the positive electrode of the direct current side, a positive electrode of the fourth diode is connected to a second terminal of the third switching transistor, and a negative electrode of the fourth diode is connected to the first terminal of the third switching transistor.

The fourth switching unit comprises a fourth switching transistor and a fifth diode. A first terminal of the fourth switching transistor is connected to the second terminal of the third switching transistor, a second terminal of the fourth switching transistor is connected to the negative electrode of the direct current side, a positive electrode of the fifth diode is connected to the second terminal of the fourth switching transistor, and a negative electrode of the fifth diode is connected to the first terminal of the fourth switching transistor;

The fifth switching unit comprises a fifth switching transistor and a sixth diode. A first terminal of the fifth switching transistor is connected to the positive electrode of the direct current side, a positive electrode of the sixth diode is connected to a second terminal of the fifth switching transistor, and a negative electrode of the sixth diode is connected to the first terminal of the fifth switching transistor.

The sixth switching unit comprises a sixth switching transistor and a seventh diode. A first terminal of the sixth switching transistor is connected to the second terminal of the fifth switching transistor, a second terminal of the sixth switching transistor is connected to the negative electrode of the direct current side, a positive electrode of the seventh diode is connected to the second terminal of the sixth switching transistor, and a negative electrode of the seventh diode is connected to the first terminal of the sixth switching transistor.

The seventh switching unit includes a seventh switching transistor and an eighth diode. A first terminal of the seventh switching transistor is connected to the second terminal of the third switching transistor, a positive electrode of the eighth diode is connected to a second terminal of the seventh switching transistor, and a negative electrode of the eighth diode is connected to the first terminal of the seventh switching transistor.

The eighth switching unit includes an eighth switching transistor and a ninth diode, a first terminal of the eighth switching transistor is connected to the second terminal of the seventh switching transistor. A second terminal of the eighth switching transistor is connected to the second terminal of the fifth switching transistor, a positive electrode of the ninth diode is connected to the second terminal of the eighth switching transistor, and a negative electrode of the ninth diode is connected to the first terminal of the eighth switching transistor.

The auxiliary switching circuit may further comprise a first capacitor, a second capacitor, a third capacitor, a fourth capacitor, a fifth capacitor, and a sixth capacitor. The first capacitor is connected between the first terminal and second terminal of the third switching transistor, the second capacitor is connected between the first terminal and second terminal of the fourth switching transistor, the third capacitor is connected between the first terminal and second terminal of the fifth switching transistor, the fourth capacitor is connected between the first terminal and second terminal of the sixth switching transistor, the fifth capacitor is connected between the first terminal and second terminal of the seventh switching transistor, and the sixth capacitor is connected between the first terminal and second terminal of the eighth switching transistor.

The third switching transistor may comprise a first capacitor, the fourth switching transistor includes a second capacitor, the fifth switching transistor includes a third capacitor, the sixth switching transistor includes a fourth capacitor, the seventh switching transistor includes a fifth capacitor, and the eighth switching transistor includes a sixth capacitor. The first capacitor is connected between the first terminal and second terminal of the third switching transistor, the second capacitor is connected between the first terminal and second terminal of the fourth switching transistor, the third capacitor is connected between the first terminal and second terminal of the fifth switching transistor, the fourth capacitor is connected between the first terminal and second terminal of the sixth switching transistor, the fifth capacitor is connected between the first terminal and second terminal of the seventh switching transistor, and the sixth capacitor is connected between the first terminal and second terminal of the eighth switching transistor.

The Heric topology circuit may further comprise a seventh capacitor and an eighth capacitor, one terminal of the seventh capacitor is connected to the positive electrode of the direct current side, the other terminal of the seventh capacitor is connected to the negative electrode of the direct current side, one terminal of the eighth capacitor is connected to the first terminal of the alternating current side, and the other terminal of the eighth capacitor is connected to the second terminal of the alternating current side.

The voltage conversion circuit may further include a controller, and the controller may be connected to a third terminal of the first switching transistor, a third terminal of the second switching transistor, a third terminal of the third switching transistor, a third terminal of the fourth switching transistor, a third terminal of the fifth switching transistor, a third terminal of the sixth switching transistor, a third terminal of the seventh switching transistor, and a third terminal of the eighth switching transistor.

The present application further provides an inverter device, including the foregoing voltage conversion circuit and a shell, where the voltage conversion circuit is accommodated in the shell, and the voltage conversion circuit is configured to convert alternating current voltage or direct current voltage into direct current voltage or alternating current voltage.

The present application further provides an energy storage device, including the foregoing voltage conversion circuit and a battery, where the voltage conversion circuit is electrically connected to the battery, and the voltage conversion circuit is configured for voltage conversion of direct current in the battery into alternating current, or voltage conversion of externally input alternating current into direct current for storage in the battery.

Beneficial effects of the present application are as follows: The auxiliary switching circuit in the present application may comprise the first switching unit, the second switching unit, the transformer, the first inductor, and the first diode. The first terminal of the first switching unit is connected to the positive electrode of the direct current side of the Heric topology circuit, the second terminal of the first switching unit is connected to the first terminal of the transformer, the first terminal of the second switching unit is connected to the second terminal of the transformer, the second terminal of the second switching unit is connected to the negative electrode of the direct current side, the positive electrode of the first diode is connected to the third terminal of the transformer, and the fourth terminal of the transformer is connected to the negative electrode of the direct current side. The first terminal of the first inductor is connected to the fifth terminal of the transformer, and the second terminal of the first inductor is connected to the midpoint of the freewheeling bridge arm in the Heric topology circuit.

In the prior art, semiconductor devices in a Heric topology circuit all have body diodes, and some of the semiconductor devices are subjected to switching losses due to hard turn-on or turn-off. In the present application, by designing the auxiliary switching circuit for the Heric topology circuit, the first switching unit or the second switching unit can assist semiconductor devices in the Heric topology circuit in zero voltage turn-on or zero current turn-off for soft turn-on or turn-off of the semiconductor devices, thereby reducing losses and lowering costs.

### BRIEF DESCRIPTION OF THE DRAWINGS

To describe the technical solutions in the present application more clearly, the accompanying drawings required for use in the description will be briefly introduced below. Apparently, the drawings in the following description show merely some examples of the present application. For a person of ordinary skill in the art, other drawings may be derived from these drawings without any creative effort. In the figures:

FIG. 1 is a schematic diagram of a voltage conversion circuit according to an example of the present application;

FIG. 2 is a timing diagram of the voltage conversion circuit in FIG. 1 according to an example;

FIG. 3 is a schematic framework diagram of an inverter device according to an example of the present application; and

FIG. 4 is a schematic framework diagram of an energy storage device according to an example of the present application.

### DETAILED DESCRIPTION

The technical solutions of the present application will be described in detail below with reference to the accompanying drawings. The following examples are merely used to illustrate the technical solutions of the present application more clearly, and therefore are examples and cannot be used to limit the scope of protection of the present application.

Unless otherwise defined, all technical and scientific terms used herein have the same meanings as those commonly understood by technical personnel in the technical field of the present application. The terms used herein are only for the purpose of describing specific examples and are not intended to limit the present application; and the terms “include” and “have” in the description and claims of the present application, the above accompanying drawings, and any variations thereof, are intended to cover non-exclusive inclusion.

In the description of the examples of the present application, the technical terms “first”, “second”, and the like are only used to distinguish different objects and cannot be understood as indicating or implying relative importance or implying a quantity, specific order, or primary and secondary relationship of the indicated technical features.

The phrase “example” referred to herein means that specific features, structures, or characteristics described in conjunction with the example may be included in at least one example of the present application. The phrase appearing at various places in the description does not necessarily refer to the same example, or an independent or alternative example exclusive of other examples. Those skilled in the art understand explicitly and implicitly that an example described herein may be combined with another example.

In the description of the present application, the term “a plurality of” means two (inclusive) or more. Similarly, “a plurality of groups” means two (inclusive) or more groups, and “a plurality of pieces” means two (inclusive) or more pieces.

In the description of the examples of the present application, the orientations or positional relationships indicated by the technical terms “center”, “longitudinal”, “transverse”, “length”, “width”, “thickness”, “upper”, “lower”, “front”, “back”, “left”, “right”, “vertical”, “horizontal”, “top”, “bottom”, “internal”, “external”, “clockwise”, “counterclockwise”, “axially”, “radially”, “circumferentially”, etc. are based on the orientations or positional relationships shown in the drawings, are merely for ease of describing the present application and simplifying the description, but do not indicate or imply that a device or element referred to must have a specific orientation or be constructed and operated in a specific orientation, and therefore cannot be understood as limitations on the present application.

In the description of the examples of the present application, unless otherwise specified and limited, the technical terms “installed”, “connected”, “connection”, “fixed”, etc. should be understood in a broad sense. For example, the term “connection” may be fixed connection, detachable connection, integration, mechanical connection, electrical connection, direct connection, indirect connection by a medium, internal communication of two elements, or interaction between two elements. A person of ordinary skill in the art may appreciate the specific meanings of the foregoing terms in the examples of the present application according to specific circumstances.

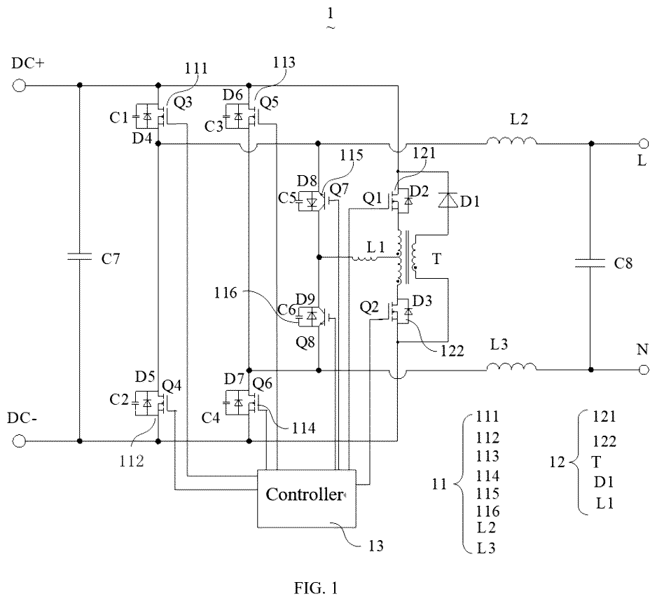

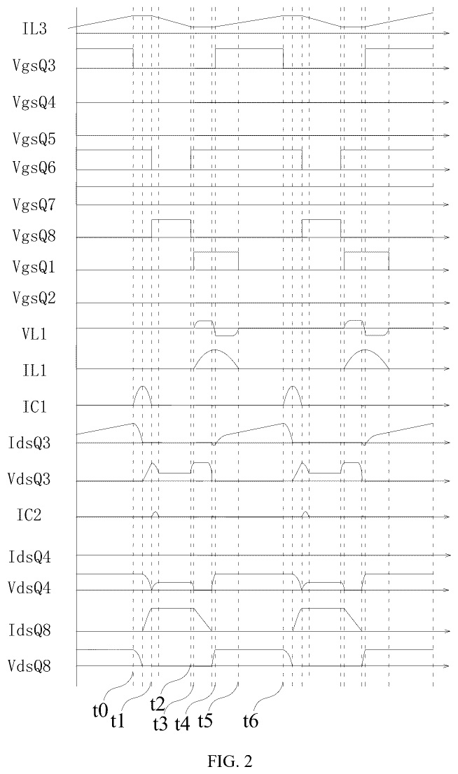

Refer to FIG. 1 and FIG. 2. FIG. 1 is a schematic diagram of a voltage conversion circuit according to an example of the present application. FIG. 2 is a timing diagram of the voltage conversion circuit in FIG. 1 according to an example. The voltage conversion circuit 1 in this example is used to implement bidirectional conversion between direct current voltage and alternating current voltage. The voltage conversion circuit 1 may also be referred to as a bidirectional DC-AC converter, with a rectification mode and an inversion mode.

The voltage conversion circuit 1 includes a Heric topology circuit 11 and an auxiliary switching circuit 12 for the Heric topology circuit 11, where the auxiliary switching circuit 12 includes a first switching unit 121, a second switching unit 122, a transformer T, a first inductor L1, and a first diode D1.

In some examples, a direct current side of the Heric topology circuit 11 may be connected to a direct current power supply, and an alternating current side of the Heric topology circuit 11 may be connected to an alternating current power supply. The direct current side of the Heric topology circuit 11 serves as a direct current side of the voltage conversion circuit 1, and the alternating current side of the Heric topology circuit 11 serves as an alternating current side of the voltage conversion circuit 1.

A first terminal of the first switching unit 121 is connected to a positive electrode DC+of the direct current side of the Heric topology circuit 11. A second terminal of the first switching unit 121 is connected to a first terminal of the transformer T. A first terminal of the second switching unit 122 is connected to a second terminal of the transformer T, and a second terminal of the second switching unit 122 is connected to a negative electrode DC-of the direct current side.

A positive electrode of the first diode D1 is connected to a third terminal of the transformer T, and a fourth terminal of the transformer T is connected to the negative electrode DC-of the direct current side. A first terminal of the first inductor L1 is connected to a fifth terminal of the transformer T, and a second terminal of the first inductor L1 is connected to a midpoint of a freewheeling bridge arm in the Heric topology circuit 11.

The first terminal, second terminal, and fifth terminal of the transformer T are three terminals of a secondary winding of the transformer T, and the fifth terminal of the transformer T is located between the first terminal and second terminal of the transformer T. The third terminal and fourth terminal of the transformer T are two terminals of a primary winding of the transformer T.

In this example, the first terminal of the first switching unit 121 is connected to the positive electrode DC+of the direct current side of the Heric topology circuit 11. The second terminal of the first switching unit 121 is connected to the first terminal of the transformer T. The first terminal of the second switching unit 122 is connected to the second terminal of the transformer T, and the second terminal of the second switching unit 122 is connected to the negative electrode DC-of the direct current side. The positive electrode of the first diode D1 is connected to the third terminal of the transformer T, and the fourth terminal of the transformer T is connected to the negative electrode DC-of the direct current side. The first terminal of the first inductor L1 is connected to the fifth terminal of the transformer T, and the second terminal of the first inductor L1 is connected to the midpoint of the freewheeling bridge arm in the Heric topology circuit 11.

In the prior art, semiconductor devices in a Heric topology circuit all have body diodes, and some of the semiconductor devices are subjected to switching losses due to hard turn-on or turn-off. In the present application, by designing the auxiliary switching circuit 12 for the Heric topology circuit 11, the first switching unit 121 or the second switching unit 122 can assist semiconductor devices in the Heric topology circuit 11 in zero voltage turn-on or zero current turn-off for soft turn-on or turn-off of the semiconductor devices, thereby reducing losses (e.g., power losses, energy losses) and lowering costs.

According to some examples of the present application, the first switching unit 121 in this example includes a first switching transistor Q1 and a second diode D2. A first terminal of the first switching transistor Q1 is connected to the positive electrode DC+of the direct current side. A second terminal of the first switching transistor Q1 is connected to the first terminal of the transformer T, a positive electrode of the second diode D2 is connected to the second terminal of the first switching transistor Q1. A negative electrode of the second diode D2 is connected to the first terminal of the first switching transistor Q1.

The second switching unit 122 includes a second switching transistor Q2 and a third diode D3. A first terminal of the second switching transistor Q2 is connected to the second terminal of the transformer T. A second terminal of the second switching transistor Q2 is connected to the negative electrode DC-of the direct current side. A positive electrode of the third diode D3 is connected to the second terminal of the second switching transistor Q2, and a negative electrode of the third diode D3 is connected to the first terminal of the second switching transistor Q2.

In some examples, the second diode D2 is a body diode of the first switching transistor Q1, and the third diode D3 is a body diode of the second switching transistor Q2. For example, both the first switching transistor Q1 and the second switching transistor Q2 may be metal oxide semiconductor (MOS) transistors with body diodes.

In some examples, both the first switching transistor Q1 and the second switching transistor Q2 may be insulated-gate bipolar transistors (IGBTs) with anti-parallel diodes, or other controllable switching transistors with anti-parallel diodes. It may be understood that the implementation forms of the switching transistors in the present application are not necessarily identical, but may be various hybrid combining forms.

According to some examples of the present application, the Heric topology circuit 11 includes a third switching unit 111, a fourth switching unit 112, a fifth switching unit 113, a sixth switching unit 114, a seventh switching unit 115, an eighth switching unit 116, a second inductor L2, and a third inductor L3.

A first terminal of the third switching unit 111 and a first terminal of the fifth switching unit 113 are connected to the positive electrode DC+ of the direct current side. A second terminal of the third switching unit 111 is connected to a first terminal of the fourth switching unit 112, and a second terminal of the fourth switching unit 112 is connected to the negative electrode DC− of the direct current side. A second terminal of the fifth switching unit 113 is connected to a first terminal of the sixth switching unit 114, and a second terminal of the sixth switching unit 114 is connected to the negative electrode DC− of the direct current side.

A first terminal of the seventh switching unit 115 is connected to the second terminal of the third switching unit 111 and a first terminal of the second inductor L2. A second terminal of the seventh switching unit 115 is connected to a first terminal of the eighth switching unit 116 and the second terminal of the first inductor L1. A second terminal of the eighth switching unit 116 is connected to the second terminal of the fifth switching unit 113 and a first terminal of the third inductor L3. A second terminal of the second inductor L2 is connected to a first terminal L of the alternating current side of the Heric topology circuit 11, and a second terminal of the third inductor L3 is connected to a second terminal N of the alternating current side.

The third switching unit 111 and the fourth switching unit 112 serve as a first inverter bridge arm of the Heric topology circuit 11, the fifth switching unit 113 and the sixth switching unit 114 serve as a second inverter bridge arm of the Heric topology circuit 11, the seventh switching unit 115 and the eighth switching unit 116 serve as a freewheeling bridge arm of the Heric topology circuit 11. A connection point between the second terminal of the seventh switching unit 115 and the first terminal of the eighth switching unit 116 serves as a midpoint of the freewheeling bridge arm.

In some examples, the third switching unit 111 includes a third switching transistor Q3 and a fourth diode D4. A first terminal of the third switching transistor Q3 is connected to the positive electrode DC+ of the direct current side. A positive electrode of the fourth diode D4 is connected to a second terminal of the third switching transistor Q3, and a negative electrode of the fourth diode D4 is connected to the first terminal of the third switching transistor Q3.

The fourth switching unit 112 includes a fourth switching transistor Q4 and a fifth diode D5. A first terminal of the fourth switching transistor Q4 is connected to the second terminal of the third switching transistor Q3. A second terminal of the fourth switching transistor Q4 is connected to the negative electrode DC-of the direct current side. A positive electrode of the fifth diode D5 is connected to the second terminal of the fourth switching transistor Q4, and a negative electrode of the fifth diode D5 is connected to the first terminal of the fourth switching transistor Q4.

The fifth switching unit 113 includes a fifth switching transistor Q5 and a sixth diode D6. A first terminal of the fifth switching transistor Q5 is connected to the positive electrode DC+ of the direct current side. A positive electrode of the sixth diode D6 is connected to a second terminal of the fifth switching transistor Q5, and a negative electrode of the sixth diode D6 is connected to the first terminal of the fifth switching transistor Q5.

The sixth switching unit 114 includes a sixth switching transistor Q6 and a seventh diode D7. A first terminal of the sixth switching transistor Q6 is connected to the second terminal of the fifth switching transistor Q5. A second terminal of the sixth switching transistor Q6 is connected to the negative electrode DC-of the direct current side. A positive electrode of the seventh diode D7 is connected to the second terminal of the sixth switching transistor Q6, and a negative electrode of the seventh diode D7 is connected to the first terminal of the sixth switching transistor Q6.

The seventh switching unit 115 includes a seventh switching transistor Q7 and an eighth diode D8. A first terminal of the seventh switching transistor Q7 is connected to the second terminal of the third switching transistor Q3. A positive electrode of the eighth diode D8 is connected to a second terminal of the seventh switching transistor Q7, and a negative electrode of the eighth diode D8 is connected to the first terminal of the seventh switching transistor Q7.

The eighth switching unit 116 includes an eighth switching transistor Q8 and a ninth diode D9. A first terminal of the eighth switching transistor Q8 is connected to the second terminal of the seventh switching transistor Q7. A second terminal of the eighth switching transistor Q8 is connected to the second terminal of the fifth switching transistor Q5. A positive electrode of the ninth diode D9 is connected to the second terminal of the eighth switching transistor Q8, and a negative electrode of the ninth diode D9 is connected to the first terminal of the eighth switching transistor Q8.

In some examples, the Heric topology circuit 11 further includes a first capacitor C1, a second capacitor C2, a third capacitor C3, a fourth capacitor C4, a fifth capacitor C5, and a sixth capacitor C6. The first capacitor C1 is connected between the first terminal and second terminal of the third switching transistor Q3, the second capacitor C2 is connected between the first terminal and second terminal of the fourth switching transistor Q4, the third capacitor C3 is connected between the first terminal and second terminal of the fifth switching transistor Q5, the fourth capacitor C4 is connected between the first terminal and second terminal of the sixth switching transistor Q6, the fifth capacitor C5 is connected between the first terminal and second terminal of the seventh switching transistor Q7, and the sixth capacitor C6 is connected between the first terminal and second terminal of the eighth switching transistor Q8.

According to some examples of the present application, the third switching transistor Q3 includes a first capacitor C1, the fourth switching transistor Q4 includes a second capacitor C2, the fifth switching transistor Q5 includes a third capacitor C3, the sixth switching transistor Q6 includes a fourth capacitor C4, the seventh switching transistor Q7 includes a fifth capacitor C5, and the eighth switching transistor Q8 includes a sixth capacitor C6.

The first capacitor C1 is connected between the first terminal and second terminal of the third switching transistor Q3, the second capacitor C2 is connected between the first terminal and second terminal of the fourth switching transistor Q4, the third capacitor C3 is connected between the first terminal and second terminal of the fifth switching transistor Q5, the fourth capacitor C4 is connected between the first terminal and second terminal of the sixth switching transistor Q6, the fifth capacitor C5 is connected between the first terminal and second terminal of the seventh switching transistor Q7, and the sixth capacitor C6 is connected between the first terminal and second terminal of the eighth switching transistor Q8.

In some examples, the first capacitor C1, the second capacitor C2, the third capacitor C3, the fourth capacitor C4, the fifth capacitor C5, and the sixth capacitor C6 may all be parasitic capacitors of the corresponding controllable switching transistors.

In some examples, the fourth diode D4 is a body diode of the third switching transistor Q3, the fifth diode D5 is a body diode of the fourth switching transistor Q4, the sixth diode D6 is a body diode of the fifth switching transistor Q5, the seventh diode D7 is a body diode of the sixth switching transistor Q6, the eighth diode D8 is a body diode of the seventh switching transistor Q7, and the ninth diode D9 is a body diode of the eighth switching transistor Q8. For example, the third switching transistor Q3, the fourth switching transistor Q4, the fifth switching transistor Q5, the sixth switching transistor Q6, the seventh switching transistor Q7, and the eighth switching transistor Q8 may all be MOS transistors with body diodes.

In some examples, the third switching transistor Q3, the fourth switching transistor Q4, the fifth switching transistor Q5, the sixth switching transistor Q6, the seventh switching transistor Q7, and the eighth switching transistor Q8 may all be IGBTs with anti-parallel diodes, or other controllable switching transistors with anti-parallel diodes.

In this example, the third switching transistor Q3 includes a first capacitor C1, the fourth switching transistor Q4 includes a second capacitor C2, the fifth switching transistor Q5 includes a third capacitor C3, the sixth switching transistor Q6 includes a fourth capacitor C4, the seventh switching transistor Q7 includes a fifth capacitor C5, and the eighth switching transistor Q8 includes a sixth capacitor C6. That is, the first capacitor C1, the second capacitor C2, the third capacitor C3, the fourth capacitor C4, the fifth capacitor C5, and the sixth capacitor C6 may all be parasitic capacitors of the corresponding controllable switching transistors.

Therefore, the first capacitor C1, the second capacitor C2, the third capacitor C3, the fourth capacitor C4, the fifth capacitor C5, and the sixth capacitor C6 do not need to be additionally designed, thereby lowering costs and enabling the circuit to be simple and easy to implement. In addition, the fourth diode D4 is a body diode of the third switching transistor Q3, the fifth diode D5 is a body diode of the fourth switching transistor Q4, the sixth diode D6 is a body diode of the fifth switching transistor Q5, the seventh diode D7 is a body diode of the sixth switching transistor Q6, the eighth diode D8 is a body diode of the seventh switching transistor Q7, and the ninth diode D9 is a body diode of the eighth switching transistor Q8. Therefore, the fourth diode D4, the fifth diode D5, the sixth diode D6, the seventh diode D7, the eighth diode D8, and the ninth diode D9 do not need to be additionally designed, thereby further lowering costs.

According to some examples of the present application, the Heric topology circuit 11 may further include a seventh capacitor C7 and an eighth capacitor C8, one terminal of the seventh capacitor C7 is connected to the positive electrode DC+of the direct current side, the other terminal of the seventh capacitor C7 is connected to the negative electrode DC-of the direct current side, one terminal of the eighth capacitor C8 is connected to the first terminal L of the alternating current side, and the other terminal of the eighth capacitor C8 is connected to the second terminal N of the alternating current side.

In some examples, the voltage conversion circuit 1 may further include a controller 13. The controller 13 may be connected to a third terminal of the first switching transistor Q1, a third terminal of the second switching transistor Q2, a third terminal of the third switching transistor Q3, a third terminal of the fourth switching transistor Q4, a third terminal of the fifth switching transistor Q5, a third terminal of the sixth switching transistor Q6, a third terminal of the seventh switching transistor Q7, and a third terminal of the eighth switching transistor Q8. The controller 13 may be configured to control the first switching transistor Q1, the second switching transistor Q2, the third switching transistor Q3, the fourth switching transistor Q4, the fifth switching transistor Q5, the sixth switching transistor Q6, the seventh switching transistor Q7, and the eighth switching transistor Q8.

The following describes the working principle of the voltage conversion circuit 1:

In some examples, the controller 13 is configured to control the third switching transistor Q3 and the sixth switching transistor Q6 to turn on (e.g., to conduct current between its terminals), the fourth switching transistor Q4 and the fifth switching transistor Q5 to turn off (e.g., to stop conducting current between its terminals), the seventh switching transistor Q7 to turn on, and the eighth switching transistor Q8 to turn off. In other examples, the controller 13 is configured to control the third switching transistor Q3 and the sixth switching transistor Q6 to turn off, the fourth switching transistor Q4 and the fifth switching transistor Q5 to turn on, the seventh switching transistor Q7 to turn on, and the eighth switching transistor Q8 to turn off.

When the controller 13 controls the seventh switching transistor Q7 to turn on, the voltage across the first terminal and second terminal of the eighth switching transistor Q8 drops to turn on the ninth diode D9, thereby achieving zero voltage turn-on, reducing losses, and lowering costs.

In some examples, the voltage conversion circuit 1 in this example is in an inversion mode, where the inversion mode includes a positive half cycle and a negative half cycle. The voltage conversion circuit 1 in this example is in the positive half cycle of the inversion mode, that is, current across the positive electrode DC+ and negative electrode DC− of the direct current side of the voltage conversion circuit 1 flows to the first terminal L and second terminal N of the alternating current side. The control process of the controller 13 in the negative half cycle of the inversion mode is the same as that in the positive half cycle of the inversion mode, and will not be repeated here.

The controller 13 is configured to control the third switching transistor Q3 and the sixth switching transistor Q6 to turn on, the fourth switching transistor Q4 and the fifth switching transistor Q5 to remain off, and the seventh switching transistor Q7 to turn on, so that the voltage conversion circuit 1 is in the positive half cycle of the inversion mode.

As shown in FIG. 1 and FIG. 2, at time t0, the controller 13 is configured to control a driving signal for the third switching transistor Q3 to switch from a first level to a second level, where the first level is a high level and the second level is a low level. That is, the driving signal for the third switching transistor Q3 switches from the high level to the low level, thereby setting the drive of the third switching transistor Q3 to low. Since the first terminal and second terminal of the third switching transistor Q3 are connected in parallel to the first capacitor C1, the voltage across the two terminals of the first capacitor C1 will not instantly become zero. When the controller 13 is configured to control the third switching transistor Q3 to turn off, the current flowing through the third switching transistor Q3 gradually flows to the first capacitor C1 (the current flowing through the third switching transistor Q3 flows from the first terminal to second terminal of the third switching transistor Q3), and then the current in the first capacitor C1 gradually increases, achieving zero voltage turn-off of the third switching transistor Q3.

After the third switching transistor Q3 is turned off, the current in the first capacitor C1 gradually decreases, and the voltage between the first terminal and second terminal of the third switching transistor Q3 gradually increases. At this time, the voltage between the first terminal and second terminal of the eighth switching transistor Q8 decreases, and the ninth diode D9 is turned on.

The third switching transistor Q3 in this example can achieve zero voltage turn-off, thereby reducing losses of the third switching transistor Q3, lowering costs, and increasing the operating frequency of the third switching transistor Q3.

In some examples, the controller 13 is configured to control a driving signal for the sixth switching transistor Q6 to switch from the first level to the second level, a driving signal for the eighth switching transistor Q8 to switch from the second level to the first level, and the ninth diode D9 to turn on, achieving zero voltage turn-on of the eighth switching transistor Q8 and zero current turn-off of the sixth switching transistor Q6.

Within an interval from time t1 to time t2, at time t1, the controller 13 is configured to control the driving signal for the sixth switching transistor Q6 to switch from the first level to the second level, thereby setting the drive of the sixth switching transistor Q6 to low. Meanwhile, the controller 13 is configured to control a driving signal for the eighth switching transistor Q8 to switch from the second level to the first level, enabling high driving for the eighth switching transistor Q8.

Within an interval from time t0 to time t1, the ninth diode D9 is turned on, thereby achieving zero voltage turn-on of the eighth switching transistor Q8 and zero current turn-off of the sixth switching transistor Q6. After the eighth switching transistor Q8 is turned on, the voltage across the first terminal L and second terminal N of the alternating current side is applied to the second inductor L2 and the third inductor L3. At this time, the current in the second inductor L2 and the current in the third inductor L3 gradually drop. The current in the second inductor L2 and the current in the third inductor L3 are recirculated through the eighth switching transistor Q8, and the eighth switching transistor Q8 provides current to the first terminal L and second terminal N of the alternating current side.

In this example, zero voltage turn-on of the eighth switching transistor Q8 and zero current turn-off of the sixth switching transistor Q6 are achieved, thereby reducing losses of the eighth switching transistor Q8 and the sixth switching transistor Q6, lowering costs, and increasing the operating frequencies of the eighth switching transistor Q8 and the sixth switching transistor Q6.

In some examples, the controller 13 is configured to control the driving signal for the eighth switching transistor Q8 to switch from the first level to the second level, and control the driving signal for the sixth switching transistor Q6 to switch from the second level to the first level, achieving zero current turn-on of the sixth switching transistor Q6 and zero voltage turn-off of the eighth switching transistor Q8.

Within an interval from time t2 to time t3, the controller 13 is configured to control the driving signal for the eighth switching transistor Q8 to switch from the first level to the second level, thereby setting the drive of the eighth switching transistor Q8 to low. The current in the eighth switching transistor Q8 is switched to the ninth diode D9, achieving zero voltage turn-off of the eighth switching transistor Q8. The controller 13 is configured to control the driving signal for the sixth switching transistor Q6 to switch from the second level to the first level, enabling high driving for the sixth switching transistor Q6. At this time, no current flows through the sixth switching transistor Q6, achieving zero current turn-on of the sixth switching transistor Q6.

In some examples, the controller 13 is configured to control a driving signal for the first switching transistor Q1 to switch from the second level to the first level, achieving zero current turn-on of the first switching transistor Q1.

The controller 13 is configured to control the driving signal for the first switching transistor Q1 to switch from the second level to the first level, thereby setting the drive of the first switching transistor Q1 to high. Since the current in the first inductor L1 cannot suddenly change, the current in the first switching transistor Q1 remains zero during the turn-on of the first switching transistor Q1, achieving zero current turn-on of the first switching transistor Q1.

The controller 13 in this example is configured to increase the current in the first inductor L1 after the first switching transistor Q1 is turned on. Under the coupling effect of the transformer T, the first diode D1 is turned on, and the voltage across the third terminal and fourth terminal of the transformer T is equal to the direct current voltage between the positive electrode DC+ and negative electrode DC− of the direct current side.

After the first switching transistor Q1 is turned on, the voltage in the first switching transistor Q1 is superimposed with the voltage in the first inductor L1 to increase the current in the first inductor L1. Under the coupling effect of the transformer T, the first diode D1 is turned on, and the voltage across the third terminal and fourth terminal of the transformer T is clamped to the voltage in the positive electrode DC+ of the direct current side, that is, the voltage across the third terminal and fourth terminal of the transformer T is equal to the direct current voltage between the positive electrode DC+ and negative electrode DC-of the direct current side. For example, the transformation ratio of the transformer T is n:n:1, and the voltage between the first terminal and second terminal of the secondary winding of the transformer T is n*VDC. At this time, the voltage across the two terminals of the first inductor L1 is (1−n)*VDC, so that the current in the first inductor L1 increases rapidly.

In this example, zero current turn-on of the first switching transistor Q1, zero current turn-on of the sixth switching transistor Q6, and zero voltage turn-off of the eighth switching transistor Q8 are achieved, thereby reducing losses of the eighth switching transistor Q8, the first switching transistor Q1, and the sixth switching transistor Q6, lowering costs, and increasing the operating frequencies of the eighth switching transistor Q8, the sixth switching transistor Q6, and the first switching transistor Q1.

In some examples, when the current in the first inductor L1 is equal to the sum of the current in the second inductor L2 and the current in the third inductor L3, the controller 13 is configured to control the current in the ninth diode D9 of the eighth switching transistor Q8 to zero, achieving zero current turn-off of the eighth switching transistor Q8.

Within an interval from time t3 to time t4, the current flowing through the first inductor L1 increases until the current in the first inductor L1 is equal to the sum of the current in the second inductor L2 and the current in the third inductor L3, and the current in the ninth diode D9 of the eighth switching transistor Q8 is zero, achieving zero current turn-off of the eighth switching transistor Q8.

When the current in the first inductor L1 is greater than the sum of the current in the second inductor L2 and the current in the third inductor L3, the controller 13 is configured to control the first inductor L1 to discharge the first capacitor C1 and charge the second capacitor C2 until the fourth diode D4 is turned on.

The current flowing through the first inductor L1 increases. Since the inductance of the second inductor L2 and the inductance of the third inductor L2 are greater than that of the first inductor L1, it can be considered that the current in the second inductor L2 and the current in the third inductor L3 remain unchanged. The current in the first inductor L1 is supplied to the second inductor L2 and the third inductor L3, and the first inductor L1 discharges the first capacitor C1 and charges the second capacitor C2, so that the voltage across the first terminal and second terminal of the fourth switching transistor Q4 gradually increases, and the voltage across the first terminal and second terminal of the third switching transistor Q3 gradually decreases until the diode of the third switching transistor Q3 is turned on.

In some examples, the controller 13 is configured to control the fourth diode D4 to turn on and control a driving signal for the third switching transistor Q3 to switch from the second level to the first level, achieving zero voltage turn-on of the third switching transistor Q3.

Within an interval from time t4 to time t5, since the fourth diode D4 is turned on within the interval from time t3 to time t4, at time t4, the controller 13 is configured to control the driving signal for the third switching transistor Q3 to switch from the second level to the first level, enabling high driving for the third switching transistor Q3, and achieving zero voltage turn-on of the third switching transistor Q3.

The controller 13 in this example is configured to control the current in the first inductor L1 to drop to zero and the current in the first diode D1 to drop to zero, achieving zero current turn-off of the first diode D1.

The node potential between the third switching transistor Q3 and the fourth switching transistor Q4 is clamped to the voltage in the positive electrode DC+of the direct current side, the voltage across the two terminals of the first inductor L1 is n*VDC, and the direction of the voltage across the two terminals of the first inductor L1 is opposite to the direction of current increase in the first inductor L1, so that the current in the first inductor L1 quickly drops to zero, and the current in the first diode D1 drops to zero, achieving zero current turn-off of the first diode D1. At this point, the voltage in the primary winding of the transformer T is no longer clamped, and the voltage in the secondary winding of the transformer T is zero. After the current in the first inductor L1 decreases to zero, because the voltage across the two terminals of the first inductor L1 remains at zero, the current in the first inductor L1 continues to be zero.

In this example, zero voltage turn-on of the third switching transistor Q3 and zero current turn-off of the first diode D1 are achieved, thereby reducing losses of the third switching transistor Q3 and the first diode D1, lowering costs, and increasing the operating frequencies of the third switching transistor Q3 and the first diode D1.

In some examples, when the current in the first switching transistor Q1 is zero, the controller 13 is configured to control a driving signal for the first switching transistor Q1 to switch from the first level to the second level, achieving zero current turn-off of the first switching transistor Q1.

Within an interval from time t5 to time t6, the current in the first switching transistor Q1 is zero, and the controller 13 is configured to control the driving signal for the first switching transistor Q1 to switch from the first level to the second level at time t5, thereby setting the drive of the first switching transistor Q1 to low and achieving zero current turn-off of the first switching transistor Q1.

When the current in the second inductor L2 and the current in the third inductor L3 increase, the controller 13 in this example is configured to control the eighth capacitor C8 to filter the current in the second inductor L2 and the current in the third inductor L3.

Within an interval from time t5 to time t6, the current in the second inductor L2 and the current in the third inductor L3 continue to increase. The current in the second inductor L2 and the current in the third inductor L3 flow through the eighth capacitor C8 and are output to the first terminal L and second terminal N of the alternating current side.

Zero current turn-off of the first switching transistor Q1 in this example is achieved, thereby reducing losses of the first switching transistor Q1, lowering costs, and increasing the operating frequency of the first switching transistor Q1.

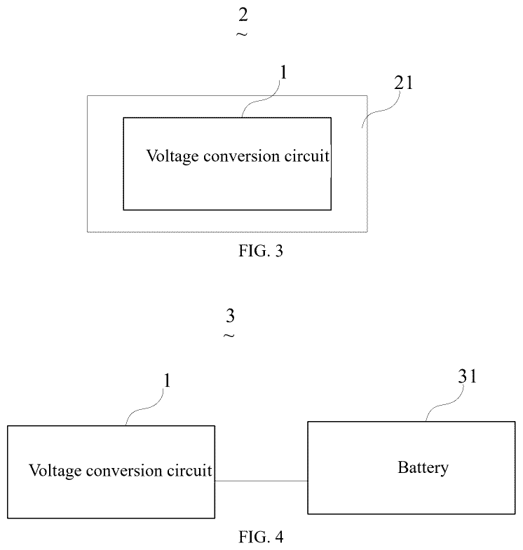

The present application further provides an inverter device. As shown in FIG. 3, the inverter device 2 includes the voltage conversion circuit 1 disclosed in the foregoing examples and a shell 21, where the voltage conversion circuit 1 is accommodated in the shell 21, and the voltage conversion circuit 1 is configured to convert alternating current voltage or direct current voltage into direct current voltage or alternating current voltage. For example, the voltage conversion circuit 1 is configured to convert alternating current voltage into direct current voltage, or the voltage conversion circuit 1 is configured to convert direct current voltage into alternating current voltage.

The present application further provides an energy storage device in, for example, a photovoltaic system. As shown in FIG. 4, the energy storage device 3 includes the voltage conversion circuit 1 disclosed in the foregoing examples and a battery 31, where the voltage conversion circuit 1 is electrically connected to the battery 31, and the voltage conversion circuit 1 is configured for voltage conversion of direct current in the battery 31 into alternating current, or the voltage conversion circuit 1 is configured to convert externally input alternating current into direct current for storage in the battery 31.

Described above are merely the examples of the present application, and the patent scope of the patent application is not limited thereto. Any equivalent structure or equivalent process transformation made using the description and drawings of the present application, directly or indirectly applied in other related technical fields, also falls within the scope of patent protection of the present application.

What is claimed is:

1. A voltage conversion circuit, comprising:
a Heric topology circuit comprising a freewheeling bridge arm; and
an auxiliary switching circuit comprising:
a first switching unit,
a second switching unit,
a transformer,
a first inductor, and
a first diode, wherein:
a first terminal of the first switching unit is connected to a positive electrode of a direct current side of the Heric topology circuit,
a second terminal of the first switching unit is connected to a first terminal of the transformer,
a first terminal of the second switching unit is connected to a second terminal of the transformer,
a second terminal of the second switching unit is connected to a negative electrode of the direct current side of the Heric topology circuit,
a positive electrode of the first diode is connected to a third terminal of the transformer,
a fourth terminal of the transformer is connected to the negative electrode of the direct current side of the Heric topology circuit,
a first terminal of the first inductor is connected to a fifth terminal of the transformer, and
a second terminal of the first inductor is connected to a midpoint of the freewheeling bridge arm in the Heric topology circuit.

2. The voltage conversion circuit according to claim 1, wherein:
the first switching unit comprises a first switching transistor and a second diode,
a first terminal of the first switching transistor is connected to the positive electrode of the direct current side of the Heric topology circuit,
a second terminal of the first switching transistor is connected to the first terminal of the transformer,
a positive electrode of the second diode is connected to the second terminal of the first switching transistor, and
a negative electrode of the second diode is connected to the first terminal of the first switching transistor; and
the second switching unit comprises a second switching transistor and a third diode,
a first terminal of the second switching transistor is connected to the second terminal of the transformer,
a second terminal of the second switching transistor is connected to the negative electrode of the direct current side of the Heric topology circuit,
a positive electrode of the third diode is connected to the second terminal of the second switching transistor, and
a negative electrode of the third diode is connected to the first terminal of the second switching transistor.

3. The voltage conversion circuit according to claim 2, wherein:
the Heric topology circuit comprises a third switching unit, a fourth switching unit, a fifth switching unit, a sixth switching unit, a seventh switching unit, an eighth switching unit, a second inductor, and a third inductor,
a first terminal of the third switching unit and a first terminal of the fifth switching unit are connected to the positive electrode of the direct current side of the Heric topology circuit,
a second terminal of the third switching unit is connected to a first terminal of the fourth switching unit,
a second terminal of the fourth switching unit is connected to the negative electrode of the direct current side of the Heric topology circuit,
a second terminal of the fifth switching unit is connected to a first terminal of the sixth switching unit,
a second terminal of the sixth switching unit is connected to the negative electrode of the direct current side of the Heric topology circuit,
a first terminal of the seventh switching unit is connected to the second terminal of the third switching unit and a first terminal of the second inductor,
a second terminal of the seventh switching unit is connected to a first terminal of the eighth switching unit and the second terminal of the first inductor,
a second terminal of the eighth switching unit is connected to the second terminal of the fifth switching unit and a first terminal of the third inductor,
a second terminal of the second inductor is connected to a first terminal of an alternating current side of the Heric topology circuit, and
a second terminal of the third inductor is connected to a second terminal of the alternating current side.

4. The voltage conversion circuit according to claim 3, wherein:
the third switching unit comprises a third switching transistor and a fourth diode,
a first terminal of the third switching transistor is connected to the positive electrode of the direct current side of the Heric topology circuit,
a positive electrode of the fourth diode is connected to a second terminal of the third switching transistor, and
a negative electrode of the fourth diode is connected to the first terminal of the third switching transistor.

5. The voltage conversion circuit according to claim 4, wherein:
the fourth switching unit comprises a fourth switching transistor and a fifth diode,
a first terminal of the fourth switching transistor is connected to the second terminal of the third switching transistor,
a second terminal of the fourth switching transistor is connected to the negative electrode of the direct current side of the Heric topology circuit,
a positive electrode of the fifth diode is connected to the second terminal of the fourth switching transistor, and
a negative electrode of the fifth diode is connected to the first terminal of the fourth switching transistor.

6. The voltage conversion circuit according to claim 5, wherein:
the fifth switching unit comprises a fifth switching transistor and a sixth diode, a first terminal of the fifth switching transistor is connected to the positive electrode of the direct current side of the Heric topology circuit, a positive electrode of the sixth diode is connected to a second terminal of the fifth switching transistor, and a negative electrode of the sixth diode is connected to the first terminal of the fifth switching transistor;
the sixth switching unit comprises a sixth switching transistor and a seventh diode, a first terminal of the sixth switching transistor is connected to the second terminal of the fifth switching transistor, a second terminal of the sixth switching transistor is connected to the negative electrode of the direct current side of the Heric topology circuit, a positive electrode of the seventh diode is connected to the second terminal of the sixth switching transistor, and a negative electrode of the seventh diode is connected to the first terminal of the sixth switching transistor;
the seventh switching unit comprises a seventh switching transistor and an eighth diode, a first terminal of the seventh switching transistor is connected to the second terminal of the third switching transistor, a positive electrode of the eighth diode is connected to a second terminal of the seventh switching transistor, and a negative electrode of the eighth diode is connected to the first terminal of the seventh switching transistor; and
the eighth switching unit comprises an eighth switching transistor and a ninth diode, a first terminal of the eighth switching transistor is connected to the second terminal of the seventh switching transistor, a second terminal of the eighth switching transistor is connected to the second terminal of the fifth switching transistor, a positive electrode of the ninth diode is connected to the second terminal of the eighth switching transistor, and a negative electrode of the ninth diode is connected to the first terminal of the eighth switching transistor.

7. The voltage conversion circuit according to claim 6, wherein:
the auxiliary switching circuit further comprises a first capacitor, a second capacitor, a third capacitor, a fourth capacitor, a fifth capacitor, and a sixth capacitor,
the first capacitor is connected between the first terminal and second terminal of the third switching transistor,
the second capacitor is connected between the first terminal and second terminal of the fourth switching transistor,
the third capacitor is connected between the first terminal and second terminal of the fifth switching transistor,
the fourth capacitor is connected between the first terminal and second terminal of the sixth switching transistor,
the fifth capacitor is connected between the first terminal and second terminal of the seventh switching transistor, and
the sixth capacitor is connected between the first terminal and second terminal of the eighth switching transistor.

8. The voltage conversion circuit according to claim 6, wherein:
the third switching transistor comprises a first capacitor, the fourth switching transistor comprises a second capacitor,
the fifth switching transistor comprises a third capacitor,
the sixth switching transistor comprises a fourth capacitor,
the seventh switching transistor comprises a fifth capacitor, and the eighth switching transistor comprises a sixth capacitor,
the first capacitor is connected between the first terminal and second terminal of the third switching transistor,
the second capacitor is connected between the first terminal and second terminal of the fourth switching transistor,
the third capacitor is connected between the first terminal and second terminal of the fifth switching transistor,
the fourth capacitor is connected between the first terminal and second terminal of the sixth switching transistor,
the fifth capacitor is connected between the first terminal and second terminal of the seventh switching transistor, and
the sixth capacitor is connected between the first terminal and second terminal of the eighth switching transistor.

9. The voltage conversion circuit according to claim 3, wherein:
the Heric topology circuit further comprises a seventh capacitor and an eighth capacitor,
the seventh capacitor is connected between the positive electrode of the direct current side of the Heric topology circuit and the negative electrode of the direct current side of the Heric topology circuit, and
the eighth capacitor is connected between the first terminal of the alternating current side of the Heric topology circuit, and the second terminal of the alternating current side of the Heric topology circuit.

10. The voltage conversion circuit according to claim 2, further comprising: a controller configured to control the first switching transistor and the second switching transistor.

11. The voltage conversion circuit according to claim 8, further comprising: a controller that is connected to a third terminal of the first switching transistor, the second terminal of the second switching transistor, a third terminal of the third switching transistor, a third terminal of the fourth switching transistor, a third terminal of the fifth switching transistor, a third terminal of the sixth switching transistor, a third terminal of the seventh switching transistor, and a third terminal of the eighth switching transistor.

12. The voltage conversion circuit according to claim 11, wherein the controller is configured to control the third switching transistor and the sixth switching transistor to turn on, control the fourth switching transistor and the fifth switching transistor to turn off, and control the seventh switching transistor to turn on and the eighth switching transistor to turn off.

13. The voltage conversion circuit according to claim 11, wherein the controller is configured to control the third switching transistor and the sixth switching transistor to turn off, control the fourth switching transistor and the fifth switching transistor to turn on, and control the eighth switching transistor to turn on and the eighth switching transistor to turn off.

14. An inverter comprising a shell and a voltage conversion circuit accommodated in the shell, wherein the voltage conversion circuit is configured to convert alternating current voltage or direct current voltage into direct current voltage or alternating current voltage, and the voltage conversion circuit comprises:
a Heric topology circuit comprising a freewheeling bridge arm; and
an auxiliary switching circuit comprising:
a first switching unit connected to a positive electrode of a direct current side of the Heric topology circuit,
a second switching unit connected to a negative electrode of the direct current side of the Heric topology circuit,
a transformer connected between the first switching unit and the second switching unit,
a first inductor, and
a first diode connected between the transformer and a midpoint of the freewheeling bridge arm in the Heric topology circuit, wherein a positive electrode of the first diode is connected to the transformer.

15. The inverter according to claim 14, wherein:
the first switching unit comprises a first switching transistor and a second diode,
a first terminal of the first switching transistor is connected to the positive electrode of the direct current side of the Heric topology circuit,
a second terminal of the first switching transistor is connected to the first terminal of the transformer,
a positive electrode of the second diode is connected to the second terminal of the first switching transistor, and
a negative electrode of the second diode is connected to the first terminal of the first switching transistor; and
the second switching unit comprises a second switching transistor and a third diode,
a first terminal of the second switching transistor is connected to the second terminal of the transformer,
a second terminal of the second switching transistor is connected to the negative electrode of the direct current side of the Heric topology circuit,
a positive electrode of the third diode is connected to the second terminal of the second switching transistor, and
a negative electrode of the third diode is connected to the first terminal of the second switching transistor.

16. The inverter according to claim 15, wherein:
the Heric topology circuit comprises a third switching unit, a fourth switching unit, a fifth switching unit, a sixth switching unit, a seventh switching unit, an eighth switching unit, a second inductor, and a third inductor,
a first terminal of the third switching unit and a first terminal of the fifth switching unit are connected to the positive electrode of the direct current side of the Heric topology circuit,
a second terminal of the third switching unit is connected to a first terminal of the fourth switching unit,
a second terminal of the fourth switching unit is connected to the negative electrode of the direct current side of the Heric topology circuit,
a second terminal of the fifth switching unit is connected to a first terminal of the sixth switching unit,
a second terminal of the sixth switching unit is connected to the negative electrode of the direct current side of the Heric topology circuit,
a first terminal of the seventh switching unit is connected to the second terminal of the third switching unit and a first terminal of the second inductor,
a second terminal of the seventh switching unit is connected to a first terminal of the eighth switching unit and the second terminal of the first inductor,
a second terminal of the eighth switching unit is connected to the second terminal of the fifth switching unit and a first terminal of the third inductor,
a second terminal of the second inductor is connected to a first terminal of an alternating current side of the Heric topology circuit, and
a second terminal of the third inductor is connected to a second terminal of the alternating current side.

17. An energy storage device, comprising:
a battery; and
a voltage conversion circuit electrically connected to the battery, wherein the voltage conversion circuit comprises:
a Heric topology circuit comprising a freewheeling bridge arm; and
an auxiliary switching circuit comprising:
a first switching unit,
a second switching unit,
a transformer,
a first inductor, and
a first diode, wherein:
a first terminal of the first switching unit is connected to a positive electrode of a direct current side of the Heric topology circuit,
a second terminal of the first switching unit is connected to a first terminal of the transformer,
a first terminal of the second switching unit is connected to a second terminal of the transformer,
a second terminal of the second switching unit is connected to a negative electrode of the direct current side of the Heric topology circuit,
a positive electrode of the first diode is connected to a third terminal of the transformer,
a fourth terminal of the transformer is connected to the negative electrode of the direct current side of the Heric topology circuit,
a first terminal of the first inductor is connected to a fifth terminal of the transformer, and
a second terminal of the first inductor is connected to a midpoint of the freewheeling bridge arm in the Heric topology circuit.

18. The energy storage device according to claim 17, wherein:
the first switching unit comprises a first switching transistor and a second diode,
a first terminal of the first switching transistor is connected to the positive electrode of the direct current side of the Heric topology circuit,
a second terminal of the first switching transistor is connected to the first terminal of the transformer,
a positive electrode of the second diode is connected to the second terminal of the first switching transistor, and
a negative electrode of the second diode is connected to the first terminal of the first switching transistor; and
the second switching unit comprises a second switching transistor and a third diode,
a first terminal of the second switching transistor is connected to the second terminal of the transformer,
a second terminal of the second switching transistor is connected to the negative electrode of the direct current side of the Heric topology circuit,
a positive electrode of the third diode is connected to the second terminal of the second switching transistor, and
a negative electrode of the third diode is connected to the first terminal of the second switching transistor.

19. The energy storage device according to claim 18, wherein:
the Heric topology circuit comprises a third switching unit, a fourth switching unit, a fifth switching unit, a sixth switching unit, a seventh switching unit, an eighth switching unit, a second inductor, and a third inductor,
a first terminal of the third switching unit and a first terminal of the fifth switching unit are connected to the positive electrode of the direct current side of the Heric topology circuit,
a second terminal of the third switching unit is connected to a first terminal of the fourth switching unit,
a second terminal of the fourth switching unit is connected to the negative electrode of the direct current side of the Heric topology circuit,
a second terminal of the fifth switching unit is connected to a first terminal of the sixth switching unit,
a second terminal of the sixth switching unit is connected to the negative electrode of the direct current side of the Heric topology circuit,
a first terminal of the seventh switching unit is connected to the second terminal of the third switching unit and a first terminal of the second inductor,
a second terminal of the seventh switching unit is connected to a first terminal of the eighth switching unit and the second terminal of the first inductor,
a second terminal of the eighth switching unit is connected to the second terminal of the fifth switching unit and a first terminal of the third inductor,
a second terminal of the second inductor is connected to a first terminal of an alternating current side of the Heric topology circuit, and
a second terminal of the third inductor is connected to a second terminal of the alternating current side.

20. The energy storage device according to claim 19, wherein:
the third switching unit comprises a third switching transistor and a fourth diode,
a first terminal of the third switching transistor is connected to the positive electrode of the direct current side of the Heric topology circuit,
a positive electrode of the fourth diode is connected to a second terminal of the third switching transistor, and
a negative electrode of the fourth diode is connected to the first terminal of the third switching transistor.
